(19) United States
(12) Patent Application Publication
(10) Pub. No.: US 2011/0063794 A1
(43) Pub. Date: Mar. 17, 2011

(54) COMPUTER WITH HEAT DISSIPATION

(75) Inventor: KUO-HSIANG WU, Tu-Cheng (TW)

(73) Assignee: HON HAI PRECISION INDUSTRY CO., LTD., Tu-Cheng (TW)

(21) Appl. No.: 12/768,530

(22) Filed: Apr. 27, 2010

(30) Foreign Application Priority Data
Sep. 15, 2009 (CN) 200910307042.9

(51) Int. Cl. G06F 1/20

(52) U.S. Cl. 361/679.47; 361/679.48

(57) ABSTRACT

A computer includes a circuit board, a heat dissipation module for facilitating dissipation of heat from the computer, and a housing for receiving the circuit board and the heat dissipation module. The heat dissipation module includes a fan and a motor. The motor is for supporting and driving the fan. The motor is electrically connected to the circuit board and directly set on the housing.

### BACKGROUND

1. Technical Field

The present disclosure relates to computers and, more particularly, to a smaller computer with a heat dissipation.

2. Description of Related Art

With the development of computer technology, electronic components such as central processing units (CPUs) have become progressively smaller, while at the same time their heat dissipation requirements have increased. Generally, heat dissipation devices are applied to the electronic components in order to facilitate dissipation of heat from the electronic components.

Nowadays, numerous kinds of heat dissipation devices have been developed for cooling the electronic components, for example, heat sinks or fans. Typically, a heat sink includes a base and a number of fins extending from a surface of the base, generally engaged with a fan adjacent to the fins. This kind of heat sink has a large volume and is popularly applied in a desktop computer because a typical enclosure of the desktop computer can provide enough space to accommodate the heat sink.

However, this heat sink is substantially unsuitable to be applied in a notebook computer due to a decreasingly limited space thereof. Specifically, due to marketing efforts and consumer preferences, designs for notebook computers tend to be increasingly thin and lightweight. For this heat sink to be accommodated in a notebook computer, there would have to be an undesirable increase in both the thickness and weight of the notebook computer.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the four views.

FIG. 1 is a schematic, isometric view of a computer including a heat dissipation, in accordance with an exemplary embodiment.

FIG. 2 is a schematic, cross-sectional view of the computer of FIG. 1.

FIG. 3 is a schematic, exploded view of the computer of FIG. 2.

FIG. 4 is a schematic, cross-sectional view of the computer of FIG. 2, with a first shielding member omitted.

### DETAILED DESCRIPTION

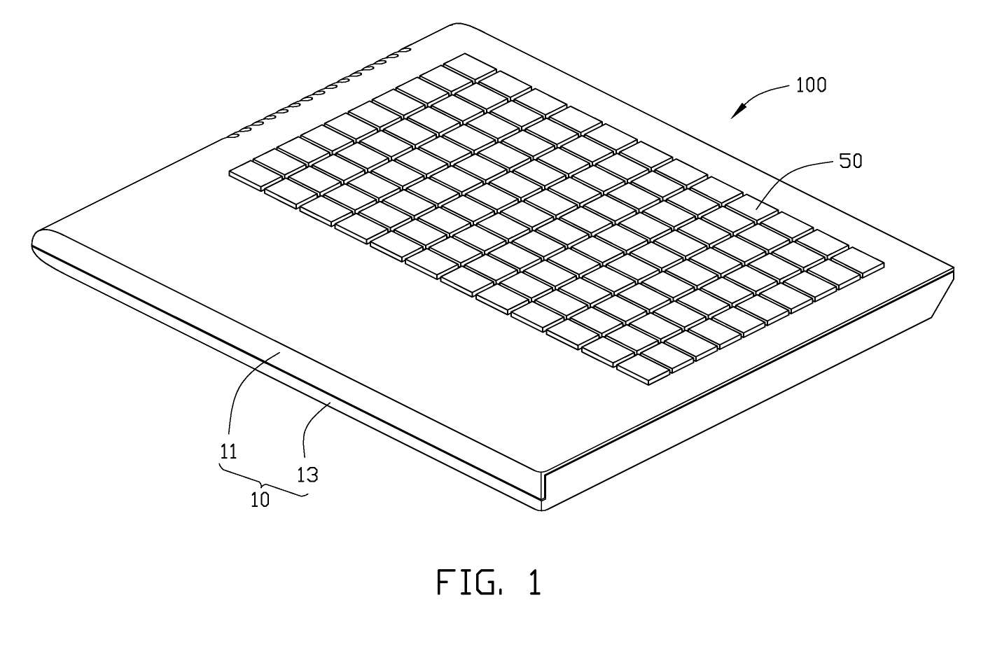

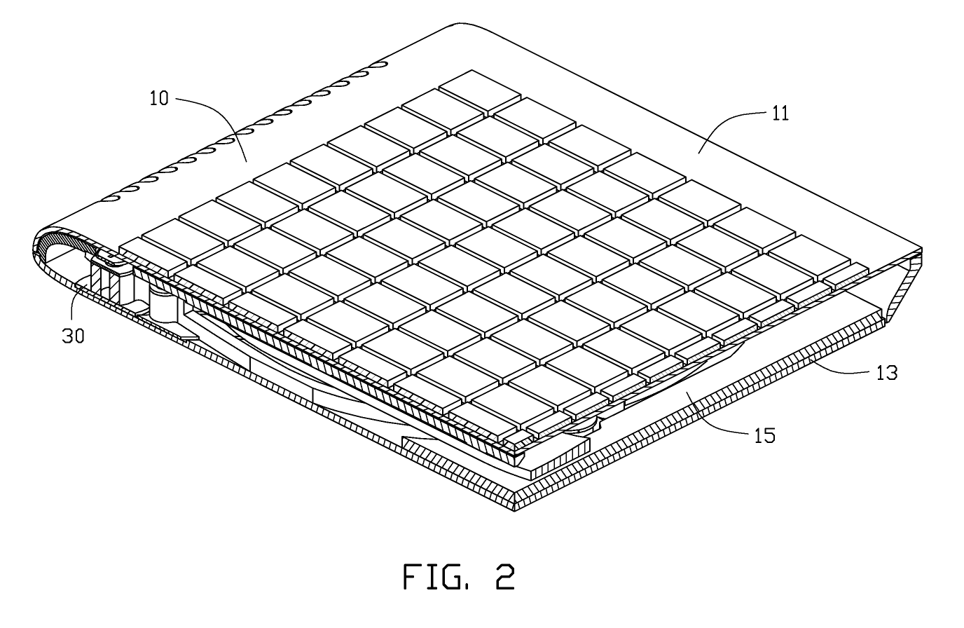

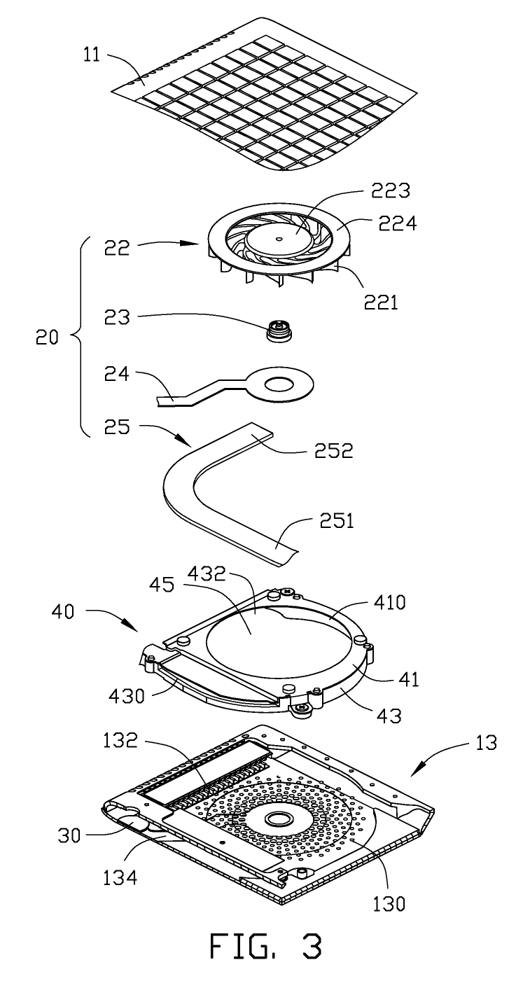

Referring to FIGS. 1, 2, and 3, a computer 100 according to an exemplary embodiment is illustrated. In this embodiment, the computer 100 is a notebook computer. The computer 100 includes a housing 10, a heat dissipation module 20, a circuit board 30, a casing 40, and a key module 50.

The housing 10 includes a first shielding member 11 and a second shielding member 13 corresponding to the first shielding member 11. The first shielding member 11 combines with the second shielding member 13 to define a receiving chamber 15. The receiving chamber 15 is for receiving the heat dissipation module 20, the circuit board 30, and the casing 40. The second shielding member 13 defines a plurality of through holes 130, a plurality of fins 132, and a blind recess 134. The plurality of through holes 130 and the plurality of fins 132 are for facilitating dissipation of heat from the computer 100. In this embodiment, the plurality of through holes 130 is positioned surrounding the heat dissipation module 20 for facilitating dissipation of heat transferred from the heat dissipation module 20.

The key module 50 is mounted on the first shielding member 11. The key module 50 is for generating different key signals. The circuit board 30 is received in the receiving chamber 15 and is set on the second shielding member 13. The circuit board 30 is electrically connected to the key module 50 to receive the different key signals.

The casing 40 is for receiving the heat dissipation module 20. The casing 40 includes a first wall 41 and a second wall 43. The first wall 41 is approximately parallel with the second shielding member 13. A through recess 410 is defined in the first wall 41. The second wall 43 perpendicularly extends from the first wall 41. The first wall 41, the second wall 43, and the second shielding member 13 cooperatively define a receiving recess 45. The receiving recess 45 communicates with the through recess 410. The heat dissipation module 20 is received in the recess 45 by passing through the through recess 410. The second wall 43 defines an opening 432 to communicate the receiving recess 45 with the plurality of through holes 130 and the plurality of fins 132, so as to facilitate dissipating heat from the computer 100 easily. The first wall 41 and the second wall 43 cooperatively define a channel 430.

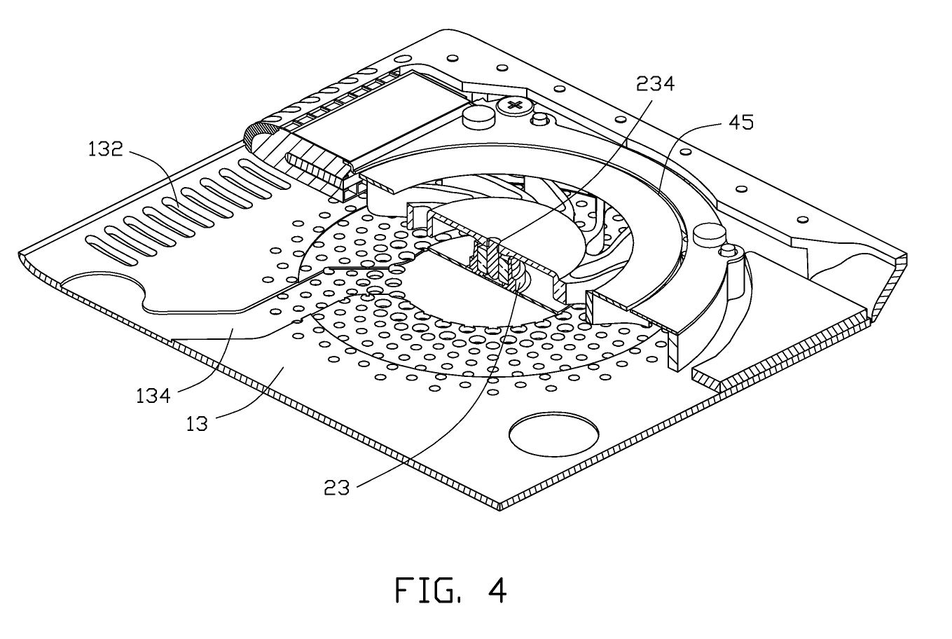

Further referring to FIG. 4, the heat dissipation module 20 is received in the receiving chamber 15 and is set on the second shielding member 13. The heat dissipation module 20 includes a fan 22, a motor 23, a flexible printed circuit (FPC) 24, and a radiating pipe 25.

The FPC 24 is received in the blind recess 134 of the second shielding member 13 and electrically connects the motor 23 to the circuit board 30.

The radiating pipe 25 is for facilitating dissipation of heat from the computer 100. The radiating pipe 25 straddles the casing 40 by running through the channel 430. The radiating pipe 25 includes an evaporator section 251 and a condenser section 252 connected to the evaporator section 251. The condenser section 252 is received in the receiving recess 45 for facilitating dissipation of heat. The evaporator section 251 extends from the condenser section 252 and protrudes out of the receiving recess 45 for absorbing heat. In this embodiment, the condenser section 252 is disposed above the plurality of fins 132 to give off heat easily. In other embodiments, in order to improve exothermic function, the radiating pipe 25 may further include an adiabatic section connected between the evaporator section 251 and the condenser section 252.

The fan 22 is received in the casing 40 through the through recess 410. The fan 22 includes a plurality of fan blades 221, a hollow rod 223, and a connecting member 224. The fan blades 221 radially extend from the rod 223. The rod 223 is for driving the fan blades 221 to rotate. The connecting member 224 is for firmly fixing the fan blades 221 and preventing the fan blades 221 moving independent of the rod 223. In other embodiments, the connecting member 224 can be omitted. In this embodiment, the height of the fan 22 is equal to that of the casing 40.

The motor 23 is set on the second shielding member 13, corresponds with the center of the receiving recess 45, and protrudes into the rod 223 to support the fan 22. The motor 23 includes a shaft 234. The shaft 234 extends from the motor 23 to connect to the rod 223. The shaft 234 is driven by the motor 23 to rotate the plurality of fan blades 221. Thus, the fan 22 is driven by the motor 23 to dissipate heat. The motor 23 is electrically connected to the circuit board 30 by the FPC 24 received in the blind recess 134, so that the motor 23 is powered by the circuit board 30. The motor 23 is directly set on the second shielding member 13 to decrease the thickness of the computer 100. In this embodiment, the motor 23 is directly adhered on the second shielding member 13 with glue.

As discussed above, the motor 23 is directly set on the second shielding member 13, unnecessary members such as a base for the heat dissipation module 20 can be omitted, and the height of the casing 40 can be decreased. Thus, the thickness of the computer 100 is decreased.

In this embodiment, the computer 100 has different ways to dissipate heat without affecting the thickness of the computer 100.

It is to be understood, however, that even though numerous embodiments have been described with reference to particular embodiments, but the present disclosure is not limited to the particular embodiments described and exemplified, and the embodiments are capable of considerable variation and modification without departure from the scope of the appended claims.

What is claimed is:

1. A computer, comprising:
a housing;
a circuit board, the circuit board received in the housing; and
a heat dissipation module, the heat dissipation module received in the housing and for facilitating dissipation of heat from the computer, the heat dissipation module comprising:
a fan; and
a motor, the motor for supporting and driving the fan, the motor electrically connected to the circuit board and directly set on the housing.

2. The computer of claim 1, wherein the housing comprises a first shielding member and a second shielding member corresponding to the first shielding member, the motor and the circuit board are set on the second shielding member, the first shielding member combines with the second shielding member to define a receiving chamber, the receiving chamber is for receiving the heat dissipation module and the circuit board.

3. The computer of claim 2, wherein the motor is set on the second shielding member by glue.

4. The computer of claim 1, wherein the heat dissipation module comprises a flexible printed circuit to electrically connect the motor to the circuit board.

5. The computer of claim 1, wherein the motor comprises a shaft, the fan comprises a plurality of fan blades and a rod, the plurality of fan blades radially extend from the rod, the shaft is received in the rod, the shaft is driven by the motor to rotate the plurality of fan blades.

6. The computer of claim 4, wherein the fan further comprises a connecting member for firmly fixing the fan blades and preventing the fan blades moving independent of the rod.

7. The computer of claim 2, further comprising a casing, the casing comprising a first wall approximately parallel with the second shielding member, and a second wall perpendicularly extends from the first wall; the first wall, the second wall, and the second shielding member cooperatively define a receiving recess.

8. The computer of claim 7, wherein the heat dissipation module further comprises a radiating pipe, one end of the radiating pipe is received in the receiving recess for facilitating dissipation of heat, the other end of radiating pipe protrudes out of the receiving recess for absorbing heat.

9. The computer of claim 7, wherein the second shielding member defines a plurality of through holes communicating with the receiving recess, the plurality of through holes surrounding the heat dissipation module for facilitating dissipation of heat.

10. The computer of claim 7, wherein the second shielding member defines a plurality of fins communicating with the receiving recess, the plurality of fins is for facilitating dissipation of heat from the computer.
